(19) United States
(12) Patent Application Publication
(10) Pub. No.: US 2020/0001243 A1
(43) Pub. Date: Jan. 2, 2020

(54) PHOTO SENSITIVE VARIABLE HYDROPHILIC MEMBRANE AND METHOD FOR MANUFACTURING THE SAME

(71) Applicant: Korea University Research and Business Foundation, Seoul (KR)

(72) Inventors: Heedeung PARK, Seongnam-si (KR); Joonhyung SHIM, Seoul (KR); Kanghee PARK, Seoul (KR); Gwondeok HAN, Seongnam-si (KR); Beomjoon KIM, Seoul (KR)

(73) Assignee: Korea University Research and Business Foundation, Seoul (KR)

(21) Appl. No.: 16/427,441

(22) Filed: May 31, 2019

(30) Foreign Application Priority Data
Jun. 29, 2018 (KR) 10-2018-0075642
Apr. 23, 2019 (KR) 10-2019-0047424

(51) Int. Cl. B01D 69/02; B01D 67/00; C02F 1/44

(52) U.S. Cl. CPC B01D 69/02; B01D 67/0088; C02F 1/44; C02F 2305/10; B01D 2325/20; B01D 2325/36; B01D 2325/38; B01D 2325/10

(57) ABSTRACT

A photo sensitive variable hydrophilic membrane includes a membrane substrate, and a photocatalyst layer deposited on the membrane substrate and including an oxide, wherein a hydrophilic property of the photocatalyst layer is increased when a light is irradiated and a method of the same are provided.

### CROSS-REFERENCE TO RELATED APPLICATIONS

A claim for priority under 35 U.S.C. § 119 is made to Korean Patent Application Nos. 10-2018-0075642 filed on Jun. 29, 2018, and 10-2019-0047424 filed on Apr. 23, 2019, in the Korean Intellectual Property Office, the entire contents of which are hereby incorporated by reference.

### BACKGROUND

Embodiments of the inventive concept described herein relate to a photo sensitive variable hydrophilic membrane and a method for manufacturing the same.

A membrane is used as a base material in various technical fields such as a gas filtration apparatus, a liquid filtration apparatus, a battery separator, clothes, and a facial mask pack for cosmetics. The demand for a fiber membrane which filters particles of a specific size, has a specific function, or is capable of being used in a specific environment has continuously increased.

A commonly used membrane includes a nonwoven fabric and a polymer nanofiber. In the case of the nonwoven fabric, a diameter of fiber is generally between 1 μm and 1000 μm, and cotton, viscose rayon, and nylon are used as a raw material for the fiber.

Because the nonwoven membrane has a high mechanical strength but has a large pore size between individual fibers, small-sized particles are not separated, and use of the nonwoven fabric is limited due to lack of a special function.

On the other hand, in recent years, a polymer nanofiber membrane, which is in the spotlight, has a diameter between 100 nm and 1000 nm, and various kinds of polymers may be used as a raw material of the polymer nanofiber membrane. Electrospinning is a typical method for fabricating such polymer nanofiber, and it is easy to control diameter, density, and porosity of nanofiber using the electrospinning In addition, the polymer nanofiber membrane is capable of being mass-produced by the electrospinning and has already been widely applied in a field of gas filtration. Further, when a polymer sensitive to temperature, solvent, and pH fabricates the nanofiber membrane using the electrospinning, various functionalities may be put on the nanofiber membrane.

However, it is impossible for a user to arbitrarily change a hydrophilic property of the membrane based on a membrane use condition, because the hydrophilic property of the membrane is already determined in a membrane fabrication process.

### SUMMARY

Embodiments of the inventive concept provide a photo sensitive variable hydrophilic membrane capable of controlling a hydrophilic property of a membrane by depositing a photocatalyst which reacts with a light on a membrane substrate, and a method of manufacturing the same.

Meanwhile, the technical problems to be solved by the inventive concept are not limited to the above-mentioned technical problems. Other technical subjects not mentioned will be apparent to those skilled in the art from the description below.

According to an exemplary embodiment, photo sensitive variable hydrophilic membrane includes a membrane substrate and a photocatalyst layer deposited on the membrane substrate and including an oxide. A hydrophilic property of the photocatalyst layer is increased when a light is irradiated

The photocatalyst layer may have a hydrophobic property when the light is blocked and has the hydrophilic property when the light is irradiated.

The membrane may have a first flux when the light is blocked, and the membrane may have a second flux larger than the first flux when the light is irradiated.

The photocatalyst layer may include any one of zinc oxide, titanium oxide, iron oxide, vanadium oxide, tungsten oxide, and cerium oxide, or a combination thereof.

The photocatalyst layer may be deposited on the membrane substrate by an atomic layer deposition (ALD).

The photocatalyst layer may have the hydrophobic property again when the light is blocked after the light is irradiated.

The photocatalyst layer may have the hydrophobic property when light in a wavelength band of 315 nm to 400 nm is blocked, and the photocatalyst layer may have the hydrophilic property when light in the wavelength band of 315 nm to 400 nm is irradiated.

According to an exemplary embodiment, a photo sensitive variable hydrophilic membrane includes a membrane substrate and a photocatalyst layer deposited on the membrane substrate and including an oxide. The photocatalyst layer has a first contact angle with regard to the water when a light is blocked,

The photocatalyst layer may have a second contact angle with regard to water smaller that the first contact angle when the light is irradiated.

The first contact angle may be 20° or more.

The second contact angle may be less than 20°.

The photocatalyst layer may include any one of zinc oxide, titanium oxide, iron oxide, vanadium oxide, tungsten oxide, and cerium oxide, or a combination thereof.

The photocatalyst layer may be deposited on the membrane substrate by an atomic layer deposition (ALD).

The photocatalyst layer may have the first contact angle with regard to the water again when the light is blocked after the light is irradiated.

According to an exemplary embodiment, a method of manufacturing a photo sensitive variable hydrophilic membrane includes preparing a membrane in which a membrane substrate is prepared inside a process chamber and depositing a photocatalyst layer in which the photocatalyst layer including an oxide is deposited on the membrane substrate, wherein in the depositing of the photocatalyst layer, the photocatalyst layer deposited has a hydrophobic property when a light is blocked and has a hydrophilic property when the light is irradiated.

The photocatalyst layer deposited in the depositing of the photocatalsyt may include any one of zinc oxide, titanium oxide, iron oxide, vanadium oxide, tungsten oxide, and cerium oxide, or a combination thereof.

The depositing of the photocatalyst may include an atomic layer deposition (ALD).

The method may further include determining whether the number of cycles of the depositing of the photocatalyst layer is a predetermined number, and terminating the depositing of the photocatalyst layer when the number of cycles of the depositing of the photocatalyst layer satisfies the predetermined number.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a cross-sectional view schematically illustrating a photo sensitive variable hydrophilic membrane according to an embodiment of the inventive concept;

FIG. 2 is an exemplary view illustrating a contact angle of a photo sensitive variable hydrophilic membrane according to an embodiment of the inventive concept with regard to water under a dark condition;

FIG. 3 is an exemplary view illustrating a contact angle of a photo sensitive variable hydrophilic membrane according to an embodiment of the inventive concept with regard to water under a light irradiation condition;

FIG. 4 is a graph comparing a contact angle between a surface of a photo sensitive variable hydrophilic membrane according to an embodiment of the inventive concept and water to a contact angle between a surface of the conventional membrane and water under a dark condition and under a light irradiation condition;

FIG. 5 is a graph comparing flux analysis results between a photo sensitive variable hydrophilic membrane according to an embodiment of the inventive concept and the conventional membrane under a dark condition and under a light irradiation condition;

FIG. 6 is a flowchart illustrating a method of manufacturing a photo sensitive variable hydrophilic membrane according to an embodiment of the inventive concept;

FIG. 7 is an exemplary view illustrating a deposition process in a method of manufacturing a photo sensitive variable hydrophilic membrane according to an embodiment of the inventive concept;

FIG. 8 is a graph illustrating an analysis result of a photo sensitive variable hydrophilic membrane based on atomic layer deposition cycle through an X-ray diffraction (XRD) method in an embodiment of the inventive concept;

FIGS. 9 to 11 are SEM images illustrating surfaces of a photo sensitive variable hydrophilic membrane based on atomic layer deposition cycle in an embodiment of the inventive concept;

FIGS. 12 to 14 are graphs illustrating EDS analysis results of a photo sensitive variable hydrophilic membrane based on atomic layer deposition cycle in an embodiment of the inventive concept;

FIG. 15 is a graph illustrating a change of a contact angle between water and a surface of a photo sensitive variable hydrophilic membrane based on atomic layer deposition cycle under a dark condition in an embodiment of the inventive concept;

FIG. 16 is a graph illustrating a change of a contact angle between water and a surface of a photo sensitive variable hydrophilic membrane based on atomic layer deposition cycle under a light irradiation condition in an embodiment of the inventive concept;

FIG. 17 is a graph illustrating absorbance of a photo sensitive variable hydrophilic membrane based on an atomic layer deposition cycle under a light irradiation condition in the embodiment of the inventive concept;

FIG. 18 is a graph illustrating transmittance of a photo sensitive variable hydrophilic membrane based on an atomic layer deposition cycle under a light irradiation condition in an embodiment of the inventive concept;

FIGS. 19 and 20 are Tauc plots illustrating optical characteristics of a photo sensitive variable hydrophilic membrane based on an atomic layer deposition cycle under a light irradiation condition in an embodiment of the inventive concept; and

FIGS. 21 to 23 are graphs illustrating results of flux analysis of a photo sensitive variable hydrophilic membrane based on an atomic layer deposition cycle in the embodiment of the inventive concept.

### DETAILED DESCRIPTION

Hereinafter, embodiments of the inventive concept will be described in detail with reference to the accompanying drawings. The embodiment of the inventive concept may be modified in various forms, and the scope of the inventive concept should not be construed as being limited to the following embodiments. These embodiments are provided to more fully describe the inventive concept to those skilled in the art. Thus, shapes of elements of the drawings have been exaggerated to emphasize a clearer description.

The inventive concept will now be described more fully hereinafter with reference to the accompanying drawings, in which preferred embodiments of the inventive concept are shown. In the drawings, like elements are designated by like reference numerals even though they are shown in different drawings, and elements of different drawings can be cited when necessary in describing the drawings.

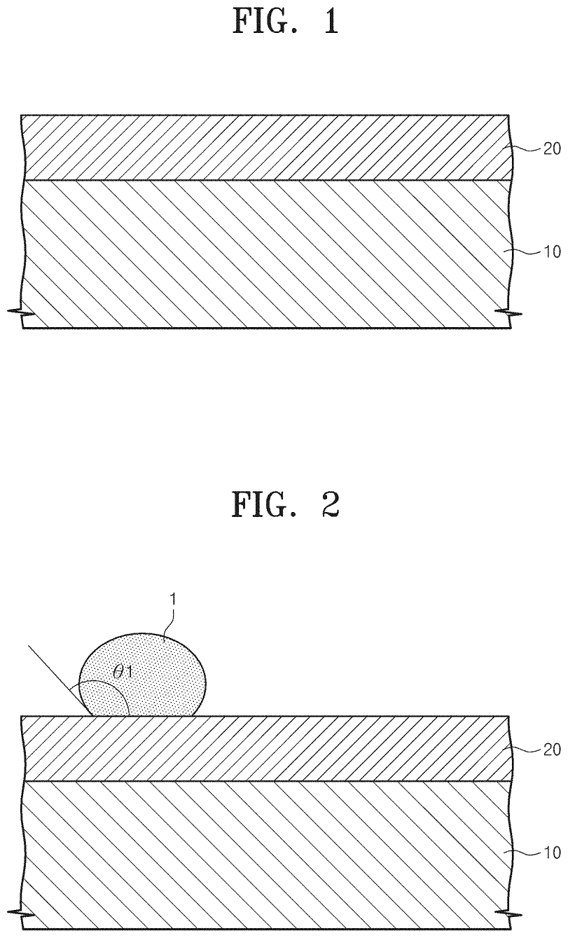

Hereinafter, referring to FIGS. 1 to 5, a photo sensitive variable hydrophilic membrane according to an embodiment of the inventive concept will be described.

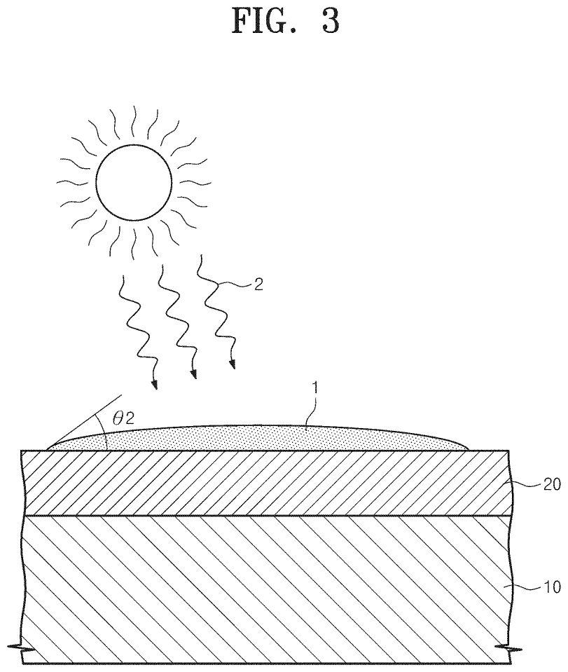

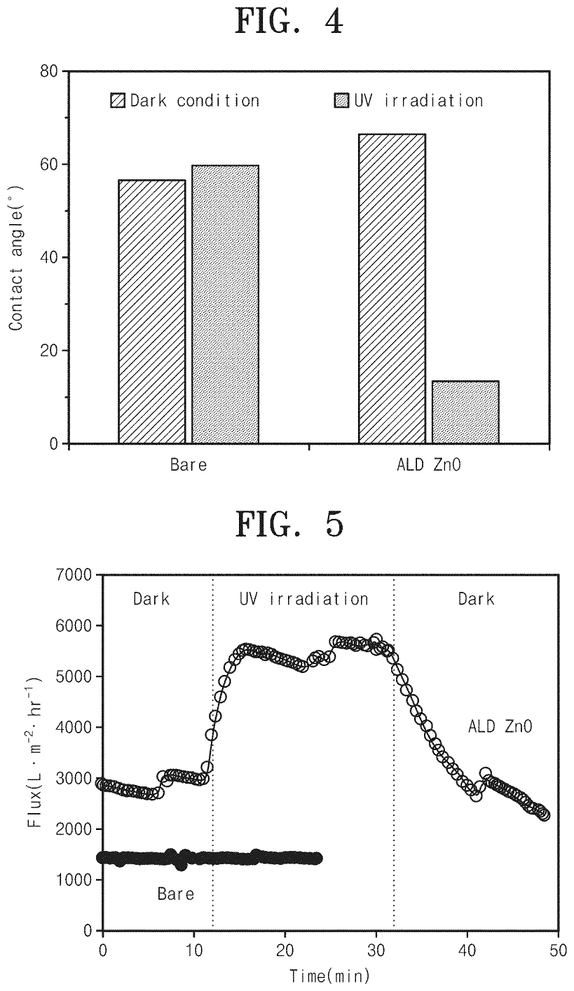

FIG. 1 is a cross-sectional view schematically illustrating a photo sensitive variable hydrophilic membrane according to an embodiment of the inventive concept, FIG. 2 is an exemplary view illustrating a contact angle of a photo sensitive variable hydrophilic membrane according to an embodiment of the inventive concept with regard to water under a dark condition, FIG. 3 is an exemplary view illustrating a contact angle of a photo sensitive variable hydrophilic membrane according to an embodiment of the inventive concept with regard to water under a light irradiation condition, FIG. 4 is a graph comparing a contact angle between a surface of a photo sensitive variable hydrophilic membrane according to an embodiment of the inventive concept and water to a contact angle between a surface of the conventional membrane and water under a dark condition and under a light irradiation condition, and FIG. 5 is a graph comparing flux analysis results between a photo sensitive variable hydrophilic membrane according to an embodiment of the inventive concept and the conventional membrane under a dark condition and under a light irradiation condition.

First, referring to FIG. 1, a photo sensitive variable hydrophilic membrane according to an embodiment of the inventive concept includes a membrane substrate 10 and a photocatalyst layer 20.

The membrane substrate 10 may be porous with micropores to selectively pass a specific component.

In an embodiment of the inventive concept, a thickness of the membrane substrate 10 may be approximately 1 mm to 100 mm, and each of a plurality of pores may be approximately 0.2 μm to 1.5 μm in size.

However, these numerical values are merely examples for carrying out the inventive concept, and thus the inventive concept is not limited thereto.

In this case, the membrane substrate 10 may include a ceramic membrane, a polymer membrane, a polyolefin membrane, a woven fiber membrane, a nonwoven fiber membrane, a monolayer membrane, and a multilayer membrane.

For example, the ceramic membrane may include titanium oxide, zirconium oxide, and aluminum oxide.

In addition, the polymer membrane may include at least one selected from the group consisting of polyvinylidene fluoride (PVDF), polyether sulfone (PES), polyacrylonitrile (PAN), polyethyleneterephthalate (PET), sulfonated polethersulfone (SPES), polyurethane (PU), and polytetrafluoroethylen (PTFE).

The photocatalyst layer 20 may be disposed on one side or the entire surfaces of the membrane substrate 10.

Meanwhile, a thickness of the photocatalyst layer 20 is preferably as thick as possible, without lowering a flux of the photo sensitive variable hydrophilic membrane.

Meanwhile, preferably, the thickness of the photocatalyst layer 20 may vary from 0.005 to 0.4 times the pore size of the membrane substrate 10 because a change in the thickness of the photocatalyst layer 20 causes a change in the size of the pores of the membrane substrate 10.

For example, in an embodiment of the inventive concept, when the pore size of the membrane substrate 10 is approximately 0.2 μm, the thickness of the photocatalyst layer 20 may be 1 nm to 80 nm.

In addition, when the pore size of the membrane substrate 10 is approximately 1.5 μm, the thickness of the photocatalyst layer 20 may be 7.5 nm to 600 nm.

Here, the thickness of the photocatalyst layer 20 is adjustable by controlling a deposition method of the photocatalyst layer 20.

Meanwhile, it is preferable that the photocatalyst layer 20 has a uniform thickness throughout the entire surface of the membrane substrate 10. To this end, in the embodiment of the inventive concept, the photocatalyst layer 20 may be deposited on the membrane substrate 10 through an atomic layer deposition (ALD) process.

In this case, the ALD process differs from a chemical vapor deposition (CVD) process or a physical vapor deposition (PVD) process in which two or more process gases required to form a specific thin film are separately supplied in sequential order at different times not to meet on gas phases, and the process gases are periodically and repeatedly supplied to allow a thin film of one monolayer to be grown per cycle.

In the ALD process, deposition is generated only by a substance (i.e., a process gas) adsorbed on a surface of a substrate. In this case, the amount of adsorption may not depend on the amount of the process gas supplied in a gaseous phase, but may be itself limited on the substrate. Therefore, there is an advantage that a layer a uniform thickness may be obtained over the entire substrate. In addition, because a thickness of the deposited layer is constant per supply period of the process gas, it is possible to control and evaluate the exact specific thickness of the layer by adjusting the number of supply cycles of the process gas. Because the ALD process performs excellent step coverage at a low temperature and exactly controls the thickness of the thin layer by simply adjusting a process parameter (a cycle of supplying a reaction material), the thin layer may have a smaller thickness comparing with the CVD process or the PVD process and the thin layer having a small amount of impurities may be obtained by improving quality of the layer.

The photocatalyst layer 20 may include an oxide.

In particular, in the embodiment of the inventive concept, zinc oxide (ZnO) may be selected as the photocatalyst layer 20.

In addition, the photocatalyst layer 20 may include any one or combination of titanium oxide, iron oxide, vanadium oxide, tungsten oxide, and cerium oxide, but the inventive concept is not limited thereto.

Referring to FIGS. 2 and 3, the surface of the photocatalyst layer 20 under the dark condition (FIG. 2) may have a first contact angle θ1 with respect to the water 1 and the surface of the photocatalyst layer 20 under the light irradiation condition may have a second contact angle θ2 with respect to the water 1.

In this case, the light may be a light of a UV-A wavelength band.

Here, the first contact angle θ1 may be implemented to have an obtuse angle relatively larger than the second contact angle θ2.

That is, in the dark condition (FIG. 2), the photocatalyst layer 20 may be hydrophobic, thereby preventing permeation of water through the membrane substrate 10.

Further, the second contact angle θ2 may be formed to have an acute angle relatively smaller than the first contact angle θ1.

That is, the photocatalyst layer 20 may be hydrophilic in the light irradiation condition (FIG. 3), thereby improving the permeation of water through the membrane substrate 10.

In this case, when the light is blocked after the light irradiation condition (FIG. 3), the photocatalyst layer 20 is changed to have the hydrophobic property again, and therefore the photocatalyst layer 20 may prevent water from being permeated through the membrane substrate 10, again.

Therefore, the photo sensitive variable hydrophilic membrane according to the embodiment of the inventive concept may selectively control the flux of water depending on the dark condition or the light irradiation condition.

Here, referring to FIGS. 4 and 5, it may be seen that the contact angle and the water flux at a UV irradiation condition of a bare membrane on which the photocatalyst layer is not deposited do not change much and are similar to each other in each of the dark condition and the UV irradiation condition.

Meanwhile, referring to FIGS. 4 and 5, it may be seen that the contact angle and the water flux of the ALD ZnO membrane according to the embodiment of the inventive concept change in each of the dark condition and the UV irradiation condition.

In detail, referring FIG. 4, it may be seen that the photocatalyst layer of the membrane according to the embodiment of the inventive concept has a smaller contact angle under the UV irradiation condition than the dark condition.

In addition, referring to FIG. 5, it may be seen that the water flux (a first flux) of the membrane according to the embodiment of the inventive concept is decreased as the contact angle of the photocatalyst layer is increased under the dark condition, while the water flux (a first flux) is increased as the contact angle of the photocatalyst layer is decreased under the UV irradiation condition.

Meanwhile, although not shown, in another embodiment of the inventive concept, the first contact angle θ1 may be formed at an acute angle relatively larger than the second contact angle θ2. For example, the first contact angle θ1 may be set in a range of 20° to 90°.

In addition, the second contact angle θ2 may be formed at an acute angle relatively smaller than the first contact angle θ1. For example, the second contact angle θ2 may be set in a range of 1° to 20°.

That is, the photocatalyst layer 20 may be hydrophilic under the dark condition and the photocatalyst layer 20 may be superhydrophilic under the light irradiation condition.

Thus, the membrane substrate 10 on which the photocatalyst layer 20 is deposited may selectively control the flux of water based on the dark condition and the UV irradiation condition.

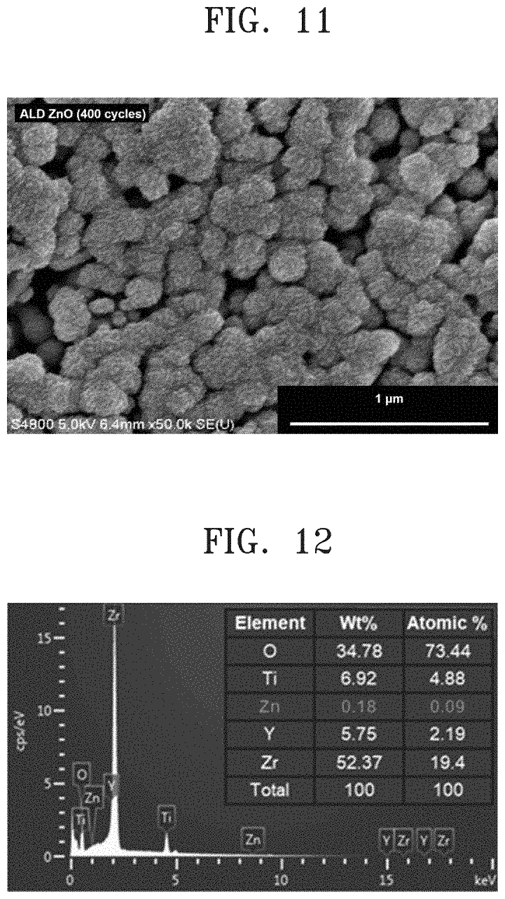

Hereinafter, with reference to FIGS. 1 to 16, a method of manufacturing the photo sensitive variable hydrophilic membrane according to an embodiment of the inventive concept will be described.

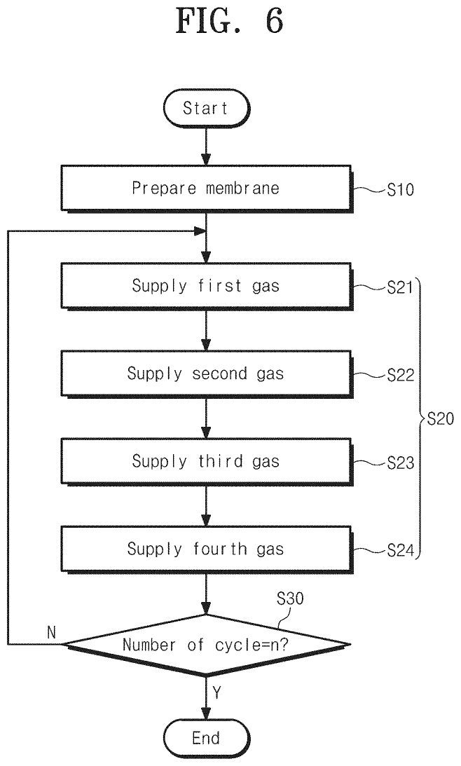

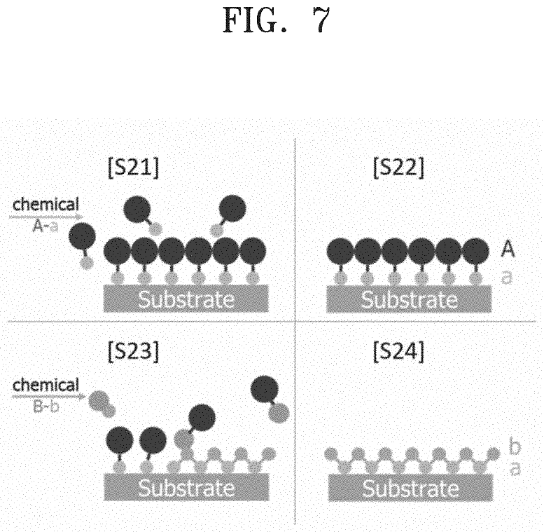

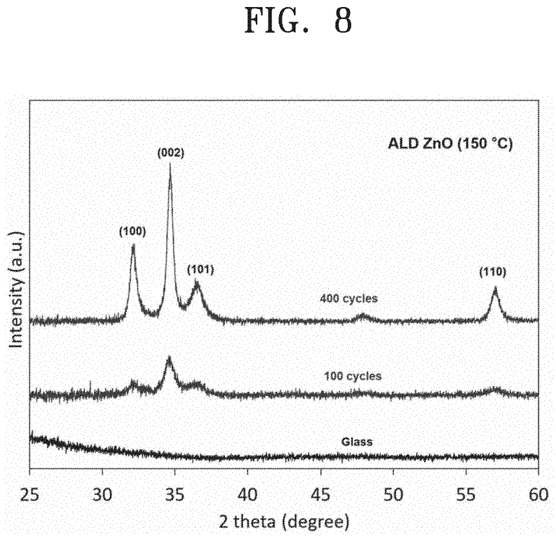

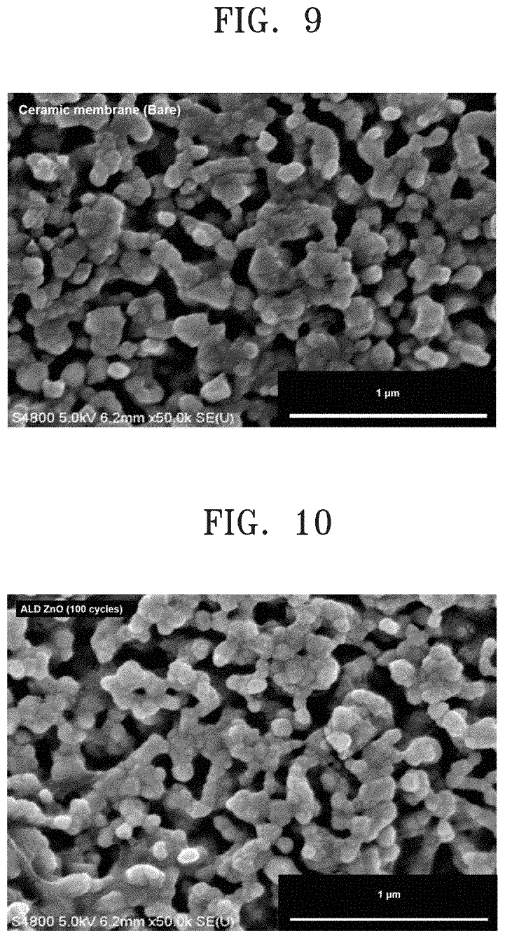

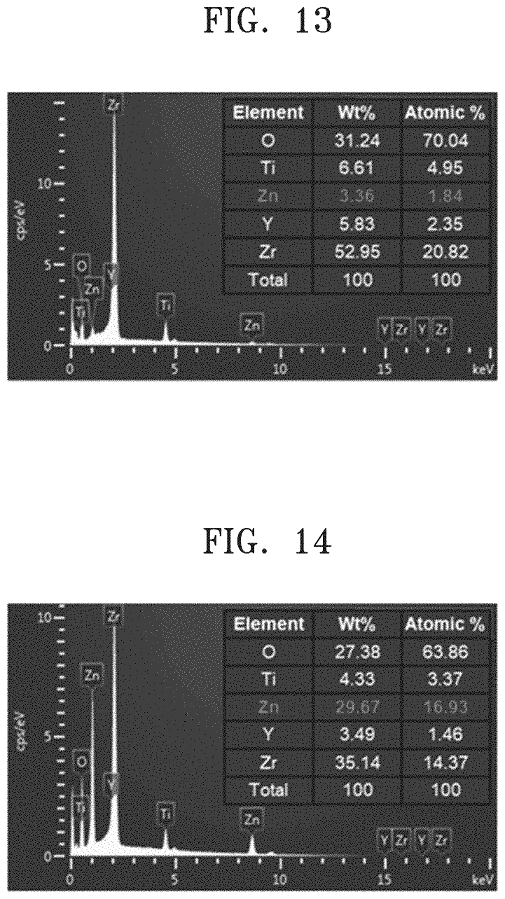

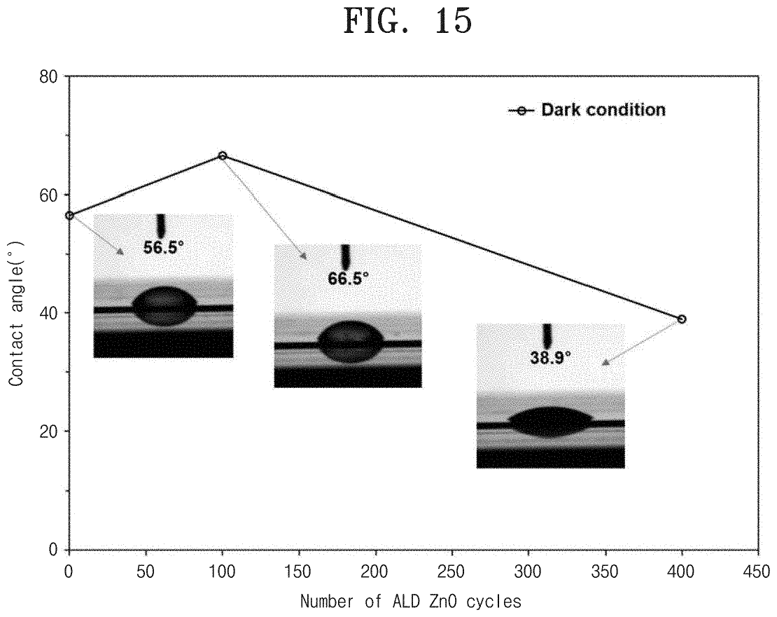

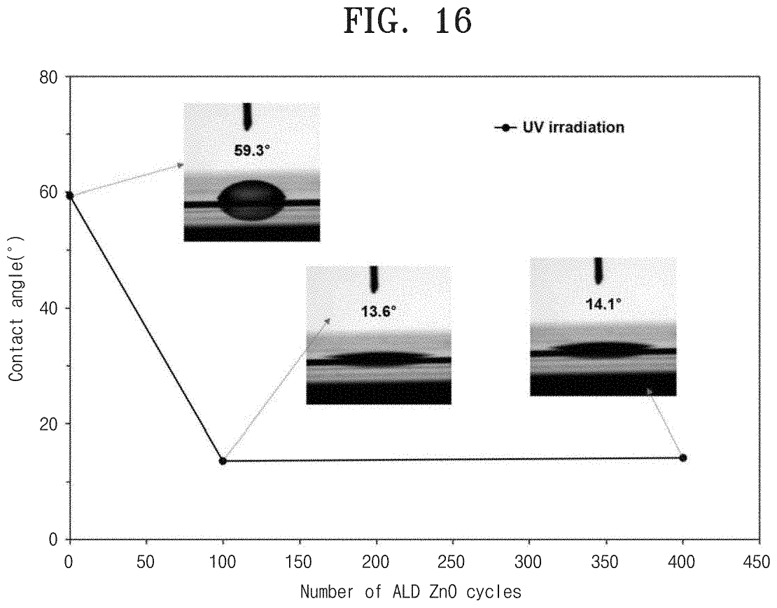

FIG. 6 is a flowchart illustrating a method of manufacturing a photo sensitive variable hydrophilic membrane according to an embodiment of the inventive concept, FIG. 7 is an exemplary view illustrating a deposition process in a method of manufacturing a photo sensitive variable hydrophilic membrane according to an embodiment of the inventive concept, FIG. 8 is a graph illustrating an analysis result of a photo sensitive variable hydrophilic membrane based on atomic layer deposition cycle through an X-ray diffraction (XRD) method in an embodiment of the inventive concept, FIGS. 9 to 11 are SEM images illustrating surfaces of a photo sensitive variable hydrophilic membrane based on atomic layer deposition cycle in an embodiment of the inventive concept, FIGS. 12 to 14 are graphs illustrating EDS analysis results of a photo sensitive variable hydrophilic membrane based on atomic layer deposition cycle in an embodiment of the inventive concept, FIG. 15 is a graph illustrating a change of a contact angle between water and a surface of a photo sensitive variable hydrophilic membrane based on atomic layer deposition cycle under a dark condition in an embodiment of the inventive concept, and FIG. 16 is a graph illustrating a change of a contact angle between water and a surface of a photo sensitive variable hydrophilic membrane based on atomic layer deposition cycle under a light irradiation condition in an embodiment of the inventive concept.

First, referring to FIG. 6, the method for manufacturing the photo sensitive variable hydrophilic membrane according to an embodiment of the inventive concept includes preparing a membrane in S10, depositing a photocatalyst in S20, and determining photocatalyst deposition cycle in S30.

In the preparing of the membrane in S10, a membrane substrate is disposed in an inner space of a chamber to perform a preparation for the depositing of the photocatalyst in S20

In this case, the membrane substrate may be porous with micropores to selectively pass a specific component.

In an embodiment of the inventive concept, a thickness of the membrane substrate may be approximately 1 mm to 100 mm, and each of a plurality of pores may be approximately 0.2 μm to 1.5 μm in size.

However, these numerical values are only illustrative examples of the inventive concept, and thus the inventive concept is not limited thereto.

In this case, the membrane substrate may include a ceramic membrane, a polymer membrane, a polyolefin membrane, a woven fiber membrane, a nonwoven fiber membrane, a monolayer membrane, and a multilayer membrane.

For example, the ceramic membrane may include titanium oxide, zirconium oxide, and aluminum oxide.

In addition, the polymer membrane may include at least one material selected from the group consisting of polyvinylidene fluoride (PVDF), polyether sulfone (PES), Polyacrylonitrile (PAN), polyethyleneterephthalate (PET), sulfonated polethersulfone (SPES), Polyurethane (PU), and polytetrafluoroethylene (PTFF).

Referring to FIG. 7, the depositing of the photocatalyst in S20 may include supplying a first gas in S21, supplying a second gas in S22, supplying a third gas in S23, and supplying a fourth gas in S24.

In this case, a process temperature in the chamber may be maintained at 50° C. to 250° C. in the depositing of the photocatalyst in S20. The process temperature is a relatively low temperature in comparison with a general temperature of metal oxide growth or deposition, and referring to FIGS. 8 to 11, it may be seen that uniform deposition is performed although the depositing of the photocatalyst is performed even at a low temperature region of 150° C. in an embodiment of the inventive concept.

In the supplying of the first gas in S21, a precursor gas A-a including a metal precursor is supplied to the membrane disposed in the chamber.

The precursor gas A-a may include an atom “a” contained in the photocatalyst to be deposited on a surface of the membrane.

In the supplying of the first gas in S21, the atom “a” contained in the precursor gas is adsorbed on the surface of the membrane.

The precursor gas may include a heteroatom “A” different from the atom “a”. Because the atom “a” and the heteroatom “A” may be bonded by physisorption, the bond therebetween is weak but the atom “a” and the surface of the membrane on which the atom “a” is absorbed is bonded by chemisorption which is stronger than physisorption.

Meanwhile, in the embodiment of the inventive concept, zinc oxide (ZnO) may be selected as the photocatalyst to be experimented, and the precursor gas may include zinc (Zn).

In addition, the photocatalyst may include any one of titanium oxide, iron oxide, vanadium oxide, tungsten oxide, and cerium oxide, or a combination thereof and the precursor gas in the supplying of the first gas in S21 may include titanium, iron, vanadium, tungsten, cerium, and the like.

In the supplying of the second gas in S22, an inert gas, i.e., a purge gas such as argon may be supplied to the membrane disposed in the chamber to perform a purge process. This is a first purge process in which the precursor physically adsorbed on the surface of the membrane and by-products remaining in the chamber are removed.

Meanwhile, in the supplying of the second gas in S22, the purge gas is supplied for about 1 second to 150 seconds to stabilize the surface of the membrane on which the precursor is adsorbed. Preferably, the purge gas may be supplied for about 100 seconds.

Because the surface is not complicated when the substrate to be deposited is a 2D flat plate such as a glass substrate, a single atomic layer may be sufficiently formed even with a short purge gas injection time in the atomic layer deposition process.

However, in an embodiment of the inventive concept, because the membrane has a complicated three-dimensional porous structure, a relatively long purge gas injection time is preferably provided for sufficient reaction and removal between the precursor and an oxidizing agent.

In the supplying of the third gas in S23, an oxidant gas B-b including an oxidizing agent “b” is supplied to the membrane disposed in the chamber. Thus, the oxidizing agent (An oxygen atom) “b” reacts with the atom “a” which is the chemically adsorbed on the surface of the membrane to form an atomic oxide “ab” on the surface of the membrane.

The oxidizing agent (An oxygen atom) “b” may include a gas containing vapor (H₂O), oxygen (O₂) plasma, ozone (O₃), nitrous oxide (N₂O) or a lycalide thereof, which is formed by inductive coupled plasma.

An oxygen atom “b” of the oxidizing agent binds to the atom “a” on the surface of the membrane to form the atomic oxide “ab” on the surface of the membrane, and the atom “A” which is physically adsorbed with the atom “a” with weak bonding force goes away. As a result, only the atomic oxide “a×b”, which is strongly chemically adsorbed to the membrane surface, remains while being absorbed on the membrane to form a photocatalyst layer of a monolayer.

Thereafter, in the supplying of the fourth gas in S24, an inert gas, i.e., a purge gas such as argon may be supplied to the membrane disposed in the chamber to perform a purge process. This is a second purge process, in which the by-products remaining in the chamber are removed.

Meanwhile, in the supplying of the fourth gas in S24, the purge gas is supplied for about 1 second to 150 seconds to stabilize the surface of the membrane on which the precursor is adsorbed. Preferably, the purge gas may be supplied for about 100 seconds.

Because the surface is not complicated when the substrate to be deposited is a 2D flat plate, a glass substrate, a single atom layer may be sufficiently formed even with a short purge gas injection time in the atomic layer deposition process.

However, in an embodiment of the inventive concept, preferably, because the membrane has a complicated three-dimensional porous structure, a relatively long purge gas injection time is preferably provided for sufficient reaction and removal between the precursor and an oxidizing agent.

Thus, one cycle of the depositing of the photocatalyst in S20 may be terminated.

In the determining of the photocatalyst deposition cycles in S30, the number of cycles of the depositing of the photocatalyst in S20 is compared with a predetermined number n. When the number of cycles of the depositing of the photocatalyst in S20 is less than the predetermined number n, the process may return to the supplying of the first gas in S21 to perform the cycle of the depositing of the photocatalyst in S20.

Meanwhile, the predetermined number n is not limited to a specific number but may be set within a range having an optimum value.

In this case, the predetermined number n is the number of cycles for satisfying the thickness of the photocatalyst layer to be deposited. The predetermined number n may be set differently depending on the material of the photocatalyst because a growth rate of the photocatalyst layer on the membrane varies depending on the material of the photocatalyst.

Meanwhile, the thickness of the photocatalyst layer is preferably as thick as possible, without lowering a flux of the photo sensitive variable hydrophilic membrane.

Meanwhile, preferably, the thickness of the photocatalyst layer may vary from 0.005 to 0.4 times the pore size of the membrane because a change in the thickness of the photocatalyst layer causes a change in the size of the pores of the membrane.

For example, in an embodiment of the inventive concept, when the pore size of the membrane is approximately 0.2 μm, the thickness of the photocatalyst layer may be 1 nm to 80 nm.

In addition, when the pore size of the membrane is approximately 1.5 μm, the thickness of the photocatalyst layer may be 7.5 nm to 600 nm.

Accordingly, in the determining of the photocatalyst deposition cycles in S30, the optimal number of repeated cycles of the depositing of the photocatalyst in S20 may be set and reflected based on the material of the photocatalyst and the size of the pores of the membrane.

Hereinafter, an embodiment of the inventive concept in which zinc oxide (ZnO) is selected as the photocatalyst will be described.

In this case, in Example 1, the cycle of the depositing of the photocatalyst in S20 was performed 100 times, and in Example 2, the cycle of the depositing of the photocatalyst in S20 was performed 400 times.

Referring to FIGS. 9 to 11, as the number of repeating cycle of the depositing of the photocatalyst in S20 is increased, it may be seen that the thickness of the photocatalyst layer is increased and the size of the pores of the membrane is decreased depending on increase in the thickness of the photocatalyst layer.

In addition, referring to FIGS. 12 to 14, an elemental composition on the surface of the photo sensitive variable hydrophilic membrane was analyzed by energy dispersive x-ray spectroscopy (EDS). As a result, it may be seen that a trace amount of zinc (Zn) element was detected on the surface of the membrane without the photocatalyst deposited by the cycle of the depositing of the photocatalyst in S20 but in Example 1 and Example 2, the amount of zinc (Zn) is increased as the number of the cycles of the depositing of the photocatalyst in S20 is increased.

Further, referring to FIGS. 15 and 16, as described above, it may be seen that the photocatalyst layer according to the inventive concept has the relatively large contact angle of water to have a hydrophobic property under the dark condition and has a relatively small contact angle of water to have a hydrophilic property under the UV irradiation condition. Namely, it may be seen that the photocatalyst layer according to the inventive concept changes the contact angle depending on whether or not the light is irradiated, thereby changing the hydrophilic property.

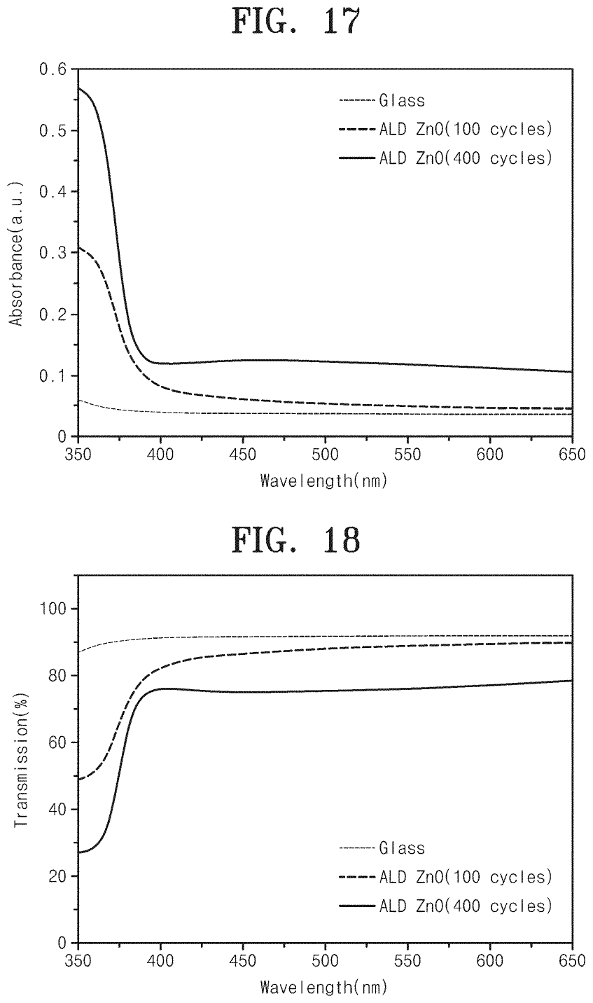

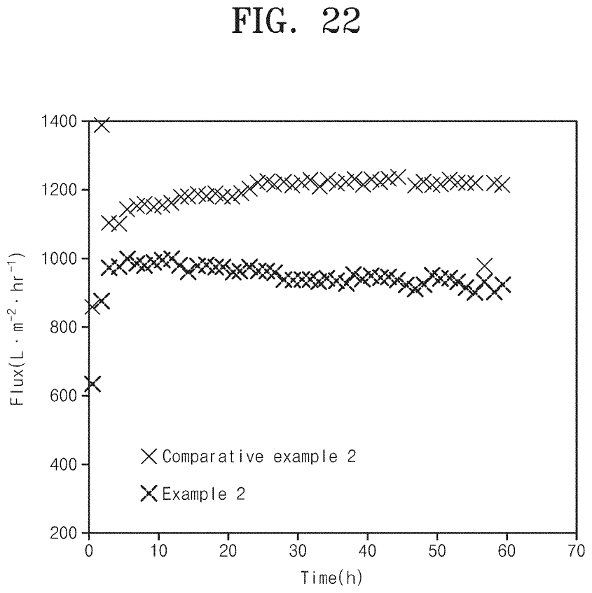

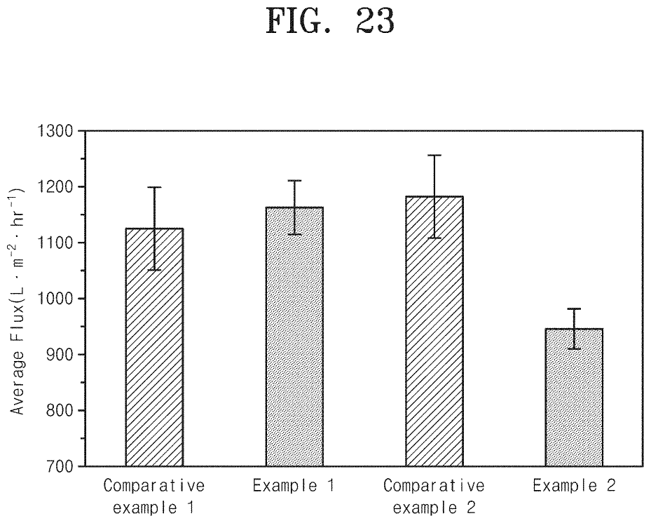

Hereinafter, characteristics of the photocatalyst layer according to an embodiment of the inventive concept will be described with reference to FIGS. 17 to 23.

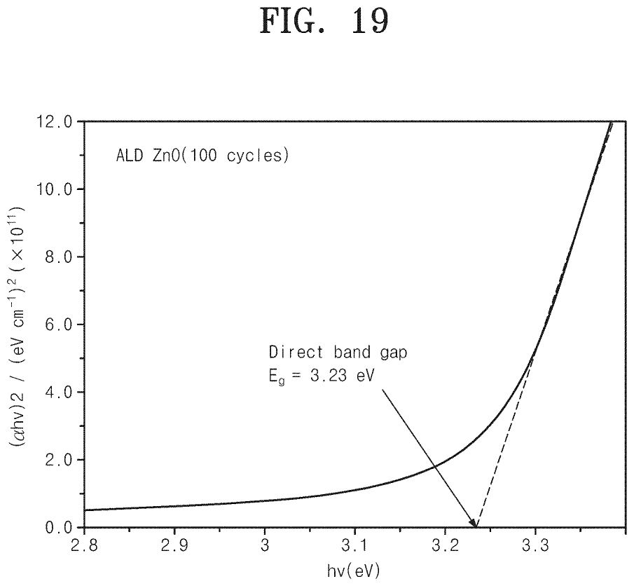

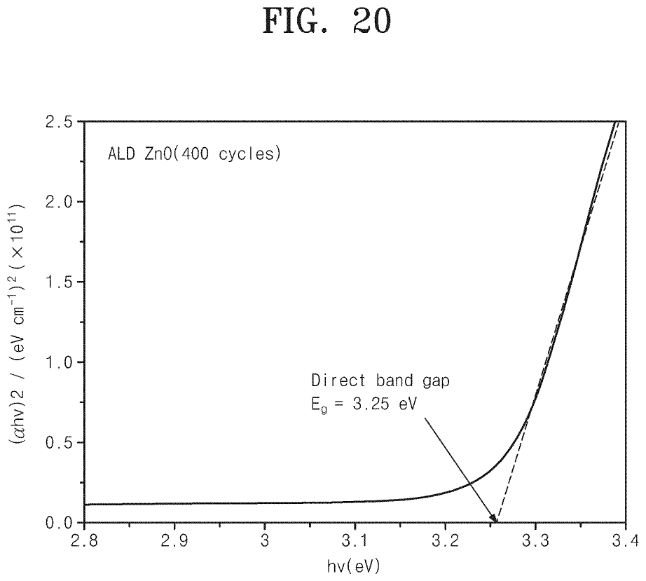

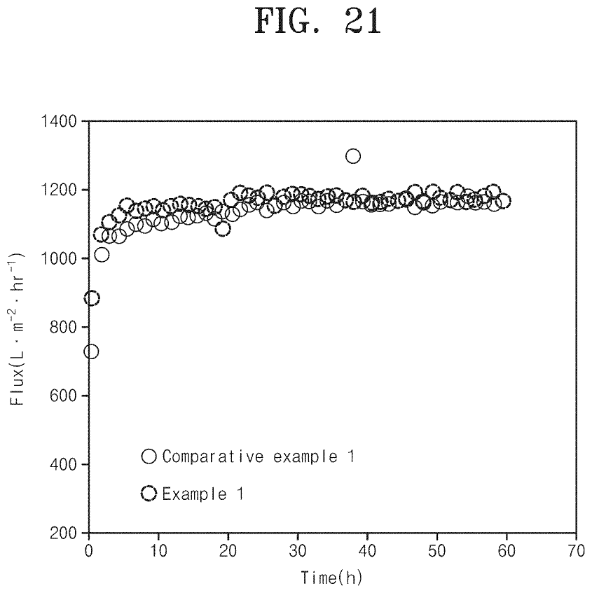

FIG. 17 is a graph illustrating absorbance of a photo sensitive variable hydrophilic membrane based on an atomic layer deposition cycle under a light irradiation condition in the embodiment of the inventive concept, FIG. 18 is a graph illustrating transmittance of a photo sensitive variable hydrophilic membrane based on an atomic layer deposition cycle under a light irradiation condition in an embodiment of the inventive concept, FIGS. 19 and 20 are Tauc plots illustrating optical characteristics of a photo sensitive variable hydrophilic membrane based on an atomic layer deposition cycle under a light irradiation condition in an embodiment of the inventive concept, and FIGS. 21 to 23 are graphs illustrating results of flux analysis of a photo sensitive variable hydrophilic membrane based on an atomic layer deposition cycle in the embodiment of the inventive concept.

First, referring to FIGS. 17 to 20, it may be seen that the photocatalyst layer according to the inventive concept has characteristics of absorbing a light of a specific wavelength band (315 nm to 400 nm) and transmitting a light of other wavelength bands.

That is, the photocatalyst layer according to the inventive concept has a hydrophilic property changed or improved upon irradiation with the light of the specific wavelength band (e.g., 315 nm to 400 nm), and therefore the hydrophilic property of the photocatalyst layer may be changed or improved when the photocatalyst layer is irradiated with the light of the specific wavelength band for the sake of convenience of a user.

Namely, the user may control the characteristics of the photocatalyst layer to allow the photocatalyst layer to absorb the light of the specific wavelength. Thus, the user may deposit the photocatalyst, which reacts only at the specific wavelength selected and changes the hydrophilic property, on the membrane.

Meanwhile, it may be seen that the flux is selectively controlled when the membrane on which the photocatalyst is deposited is applied to a water treatment.

Meanwhile, referring to FIGS. 21 to 23, the results of flux evaluation may be seen by applying the photo sensitive variable hydrophilic membrane on which the photocatalyst layer is deposited to a water-filtering membrane of the water treatment.

It may be seen that flux value in Example 1 (100 times of photocatalyst deposition added to Comparative Example 1) is further improved as compared with the membrane (Comparative Example 1) on which no photocatalyst layer is deposited.

However, it may be seen that the flux value in Example 2 (400 times of photocatalyst deposition added to Comparative Example 2) is relatively lowered as compared with the membrane (Comparative Example 2) on which no photocatalyst layer is deposited.

As described above, it may be seen that the flux value is lowered when a range of the predetermined number n is exceeded because, as the number of repeating cycles of the depositing of the photocatalyst S20 is increased, the thickness of the photocatalyst layer is increased and thus the size of the pores of the membrane is decreased.

Namely, when a flux value of wastewater filtered through the photo sensitive variable hydrophilic membrane is maintained at a high value, it is possible to produce production water having a large flow rate relative to the same membrane (membrane) area during the water treatment, thereby economically operating water treatment facilities.

According to an embodiment of the inventive concept, the photocatalyst which reacts with the light is deposited on the membrane substrate to control the hydrophilic property of the membrane.

In addition, according to an embodiment of the inventive concept, using the atomic layer deposition method, uniform photocatalyst deposition may be performed on the surface of the membrane having the complicated pore structure and the photocatalyst is firmly bonded even at the low temperature, thereby expecting excellent reliability.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A photo sensitive variable hydrophilic membrane, the membrane comprising:
a membrane substrate; and
a photocatalyst layer deposited on the membrane substrate and including an oxide,
wherein a hydrophilic property of the photocatalyst layer is increased when a light is irradiated.

2. The membrane of claim 1, wherein the photocatalyst layer has a hydrophobic property when the light is blocked and has the hydrophilic property when the light is irradiated.

3. The membrane of claim 1, wherein the membrane has a first flux when the light is blocked, and
wherein the membrane has a second flux larger than the first flux when the light is irradiated.

4. The membrane of claim 1, wherein the photocatalyst layer includes any one of zinc oxide, titanium oxide, iron oxide, vanadium oxide, tungsten oxide, and cerium oxide, or a combination thereof.

5. The membrane of claim 1, wherein the photocatalyst layer is deposited on the membrane substrate by an atomic layer deposition (ALD).

6. The membrane of claim 2, wherein the photocatalyst layer has the hydrophobic property again when the light is blocked after the light is irradiated.

7. The membrane of claim 2, wherein the photocatalyst layer has the hydrophobic property when light in a wavelength band of 315 nm to 400 nm is blocked, and
wherein the photocatalyst layer has the hydrophilic property when light in the wavelength band of 315 nm to 400 nm is irradiated.

8. A photo sensitive variable hydrophilic membrane, the membrane comprising:
a membrane substrate; and
a photocatalyst layer deposited on the membrane substrate and including an oxide,
wherein the photocatalyst layer has a first contact angle with regard to water when a light is blocked, and
wherein the photocatalyst layer has a second contact angle with regard to the water smaller that the first contact angle when the light is irradiated.

9. The membrane of claim 8, wherein the first contact angle is 20° or more, and
wherein the second contact angle is less than 20°.

10. The membrane of claim 8, wherein the photocatalyst layer includes any one of zinc oxide, titanium oxide, iron oxide, vanadium oxide, tungsten oxide, and cerium oxide, or a combination thereof.

11. The membrane of claim 8, wherein the photocatalyst layer is deposited on the membrane substrate by an atomic layer deposition (ALD).

12. The membrane of claim 8, wherein the photocatalyst layer has the first contact angle with regard to the water again when the light is blocked after the light is irradiated.

13. A method of manufacturing a photo sensitive variable hydrophilic membrane, the method comprising:
preparing a membrane in which a membrane substrate is prepared inside a process chamber; and
depositing a photocatalyst layer in which the photocatalyst layer including an oxide is deposited on the membrane substrate,
wherein in the depositing of the photocatalyst layer, the photocatalyst layer deposited has a hydrophobic property when a light is blocked and has a hydrophilic property when the light is irradiated.

14. The method of claim 13, wherein the photocatalyst layer deposited in the depositing of the photocatalsyt includes any one of zinc oxide, titanium oxide, iron oxide, vanadium oxide, tungsten oxide, and cerium oxide, or a combination thereof.

15. The method of claim 13, wherein the depositing of the photocatalyst includes an atomic layer deposition (ALD).

16. The method of claim 13, further comprising:
determining whether the number of cycles of the depositing of the photocatalyst layer is a predetermined number, and
terminating the depositing of the photocatalyst layer when the number of cycles of the depositing of the photocatalyst layer satisfies the predetermined number.
